(19) United States
(12) Patent Application Publication
(10) Pub. No.: US 2015/0002253 A1
(43) Pub. Date: Jan. 1, 2015

(54) THIN-LAYER TYPE COMMON MODE FILTER AND METHOD FOR PREPARING THE SAME

(71) Applicant: SAMSUNG ELECTRO-MECHANICS CO., LTD., Suwon-Si (KR)

(72) Inventors: Yong Il KWON, Suwon-Si (KR); Eun Sil KIM, Suwon-Si (KR); Keun Yong LEE, Suwon-Si (KR); Sang Hyun SHIN, Suwon-Si (KR)

(73) Assignee: SAMSUNG ELECTRO-MECHANICS CO., LTD., Suwon-Si (KR)

(21) Appl. No.: 14/259,850

(22) Filed: Apr. 23, 2014

(30) Foreign Application Priority Data
Jun. 28, 2013 (KR) 10-2013-0075683

(51) Int. Cl. H01F 27/24; H01F 41/02

(52) U.S. Cl. CPC H01F 27/24; H01F 41/02
USPC 336/219; 29/602.1

(57) ABSTRACT

Disclosed herein are a thin-layer type common mode filter and a method for preparing the same. The thin-layer type common mode filter includes: a ferrite substrate; a primer layer formed on the ferrite substrate; and a photosensitive insulating layer formed on the primer layer, wherein the primer layer is formed by chemically coupling the ferrite substrate with the photosensitive insulating layer. Therefore, the thin-layer type common mode filter according to the exemplary embodiments of the present invention may simultaneously apply the mechanical surface treatment method and the primer layer chemically coupled with the ferrite substrate and the photosensitive insulating layer to increase the interlayer adhesion, thereby increasing the reliability of the common mode filter.

This application claims the foreign priority benefit under 35 U.S.C. Section 119 of Korean Patent Application Serial No. 10-2013-0075683 entitled “Thin-Layer Type Common Mode Filter And Method For Preparing The Same” filed on Jun. 28, 2013, which is hereby incorporated by reference in its entirety into this application.

### BACKGROUND OF THE INVENTION

1. Technical Field

The present invention relates to a thin-layer type common mode filter and a method for preparing the same.

2. Description of the Related Art

A process of preparing the existing thin-layer type common mode filter is performed in an order of applying an insulating layer on one side of a soft magnetic sintering ferrite wafer substrate and then forming a one-layer coil using a semi-additive process, and the like, forming a via for interlayer connection on a photosensitive insulating layer on the one-layer coil and then again forming a two-layer coil using the SAP process, and the like, and applying the photosensitive insulating layer and then forming an external electrode. In this case, in order to increase the physical adhesion between the soft magnetic sintering ferrite wafer made of a ceramic material and the photosensitive insulating layer made of resin, a method for controlling surface roughness on the soft magnetic sintering ferrite wafer substrate using a physical method has been used.

That is, next, FIG. 1 illustrates an interface between the sintering ferrite substrate 10 and the photosensitive insulating layer 30 at the time of preparing the existing thin-layer type common mode filter. In this case, the method for increasing the physical adhesion with the insulating layer by controlling surface roughness 11 of the ferrite substrate using a method, such as surface grinding, and the like, has been used.

However, the adhesion is a physical coupling and therefore has intensity of force smaller than a chemical coupling and the interface between the sintering ferrite and the photosensitive insulating layer which are made of a heterogeneous material is more vulnerable than the interface between resins which are a homogeneous material. Actually, a delamination between the ferrite wafer and the resin layer may occur at the time of testing reliability.

### RELATED ART DOCUMENT

### Patent Document

(Patent Document 1) Japanese Patent Laid-Open Publication No. 1994-282836

### SUMMARY OF THE INVENTION

An object of the present invention is to provide a thin-layer type common mode filter capable of solving an interface delamination problem between a ferrite substrate and a photosensitive insulating layer by increasing an adhesion between the ferrite substrate and the photosensitive insulating layer which are made of a heterogeneous material.

Further, another object of the present invention is to provide a method for preparing a thin-layer type common mode filter.

According to an exemplary embodiment of the present invention, there is provided a thin-layer type common mode filter, including: a ferrite substrate; a primer layer formed on the ferrite substrate; and a photosensitive insulating layer formed on the primer layer, wherein the primer layer is formed by chemically coupling the ferrite substrate with the photosensitive insulating layer.

The primer layer may include a portion which is formed by being chemically coupled with ferrite within the ferrite substrate by penetrating a primer material included in the primer layer into the ferrite substrate.

The ferrite substrate may have a surface roughness of 0.4 to 0.8 μm.

The surface roughness of the ferrite substrate may be formed with mechanical surface treatment.

A thickness of the primer layer to the surface roughness of the ferrite substrate may be 0.1 to 50%.

The primer layer may be made of a material including two or more functional groups which is chemically coupled with the ferrite substrate and the photosensitive insulating layer.

The material including the two or more functional groups may include one or more material selected from the group consisting of 10-methacryloyloxydecyl dihydrogen phosphate (MDP), 2-methacryloyloxyethyl dihydrogen phosphate (MEP), and 3-trimethoxysilylpropyl methacrylate.

The primer layer may have a thickness of 1 to 200 nm.

The primer layer may be formed on one surface or both surfaces of the ferrite substrate.

The ferrite substrate may be made of one or more material selected from the group consisting of spinel ferrite, garnet ferrite, hexagonal ferrite, and a mixed ferrite thereof.

The photosensitive insulating layer may be made of one or more material selected from the group consisting of hydroxystyrene derivative, naphthoquinonediazide ester, trisphenol, and melamine compound.

According to another exemplary embodiment of the present invention, there is provided a method for preparing a thin-layer type common mode filter, including: applying a primer layer on a ferrite substrate; forming chemical coupling by reacting ferrite of the ferrite substrate with the primer layer; applying a photosensitive insulating layer on the primer layer; and forming the chemical coupling by reacting the primer layer with the photosensitive insulating layer.

The method for preparing a thin-layer type common mode filter may further include: forming surface roughness of the substrate by mechanically surface-treating the ferrite substrate.

The primer layer may be formed on one surface or both surfaces of the ferrite substrate.

### BRIEF DESCRIPTION OF THE DRAWINGS

FIG. 1 illustrates an interface between a sintering ferrite substrate and a photosensitive insulating layer at the time of preparing a thin-layer type common mode filter according to the related art.

FIG. 2 illustrates an interface between a sintering ferrite substrate and a photosensitive insulating layer of a thin-layer type common mode filter according to an exemplary embodiment of the present invention.

FIG. 3 illustrates an interface between the sintering ferrite substrate and the photosensitive insulating layer of a thin-layer type common mode filter according to another exemplary embodiment of the present invention and illustrates a structure in which a primer layer and a photosensitive insulating layer are disposed on both surfaces of the ferrite substrate.

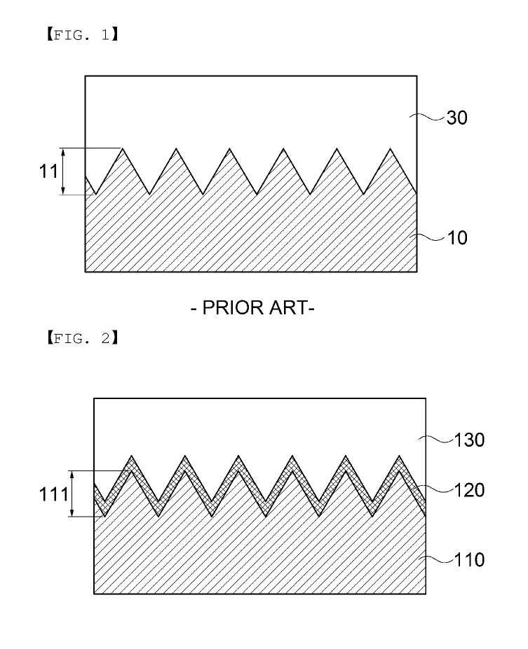

### DESCRIPTION OF THE PREFERRED EMBODIMENTS

Hereinafter, the present invention will be described in more detail. Unless explicitly described to the contrary, a singular form includes a plural form in the present specification. Further, it will be further understood that the terms “comprises” or “comprising” when used in this specification, specify the presence of stated features, integers, steps, operations, elements, or components, but do not preclude the presence or addition of one or more other features, integers, steps, operations, elements, components, or groups thereof.

The present invention relates to a thin-layer type common mode filter capable of improving an adhesion at an interface between a sintering ferrite substrate and a photosensitive insulating layer and a method for preparing the same.

The thin-layer type common mode filter according to an exemplary embodiment of the present invention proposes a method for increasing an adhesion at the interface by a method for first applying a primer layer on the sintering ferrite substrate, prior to applying a first insulating layer on the sintering ferrite substrate.

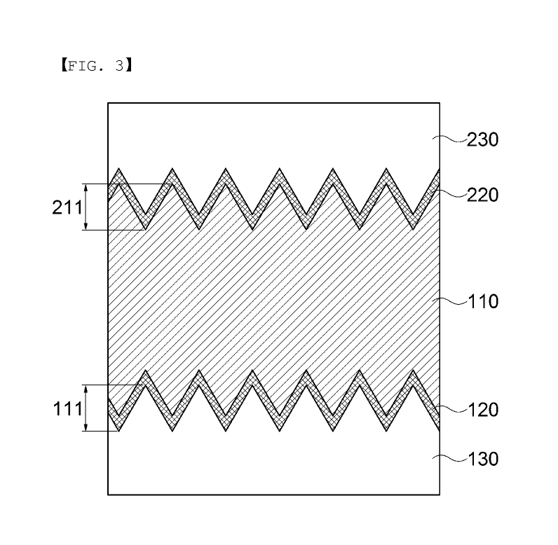

That is, referring next to FIG. 2, the thin-layer type common mode filter according to the exemplary embodiment of the present invention includes a ferrite substrate 110, a primer layer 120 formed on the ferrite substrate 110, and a photosensitive insulating layer 130 formed on the primer layer 120, in which the primer layer 120 is chemically coupled with the ferrite substrate 110 and the photosensitive insulating layer 130.

The primer layer 120 according to the exemplary embodiment of the present invention is formed by simultaneously chemically coupling with both of the sintering ferrite substrate material which is a ceramic material and resin forming the photosensitive insulating layer 130 for forming a circuit to increase an interlayer adhesion at the interface between the sintering ferrite substrate 110 and the photosensitive insulating layer 130, thereby increasing the reliability of the common mode filter.

The primer layer 120 according to the exemplary embodiment of the present invention includes a portion which is chemically coupled with ferrite within the sintering ferrite substrate 110 by penetrating a primer material included in the primer layer 120 into the sintering ferrite substrate 110 to a predetermined depth.

Further, the ferrite substrate 110 according to the exemplary embodiment of the present invention, that is, a surface of the ferrite substrate 110 is mechanically treated by using a method, such as surface grinding, before the primer layer 120 is formed, thereby forming the constant roughness 111 on the surface thereof.

The ferrite substrate 110 may have the surface roughness of 1 μm or less, preferably, 0.4 to 0.8 μm and the ferrite substrate 110 has the surface roughness to be able to increase the interlayer adhesion at the interface between the sintering ferrite substrate 110 and the photosensitive insulating layer 130.

Further, in general, a thickness of the primer layer 120 is smaller than a surface roughness Ra of the sintering ferrite substrate 110, such that the interface between the primer layer 120 and the photosensitive insulating layer 130 is uneven and maintains the surface roughness larger than 0, thereby maintaining the interlayer physical adhesion.

Therefore, the primer layer 120 according to the exemplary embodiment of the present invention may have a thickness of 1 to 200 nm.

According to the exemplary embodiment of the present invention, when the primer layer 120 is formed on the ferrite substrate 110 formed with the surface roughness, the thickness of the primer layer 120 to the surface roughness of the ferrite substrate 110 may be 0.1 to 50%. When the thickness of the primer layer 120 to the surface roughness of the ferrite substrate 110 is too thick, this causes the mechanical surface treatment to useless, and as a result, the primer layer 120 may be formed along the shape of the surface roughness while the ferrite substrate 110 maintains the surface roughness.

Further, the primer layer 120 according to the exemplary embodiment of the present invention may be made of a material including two or more functional groups which are chemically coupled with the ferrite substrate 110 and the photosensitive insulating layer 120.

The ferrite substrate 110 according to the exemplary embodiment of the present invention may be formed of one or more material selected from the group consisting of spinel ferrite, garnet ferrite, hexagonal ferrite, and a mixed ferrite thereof.

Therefore, the primer layer 120 according to the exemplary embodiment of the present invention includes a functional group which may be chemically coupled with a metal oxide layer of the ferrite substrate material, for example, a phosphate group, a hydroxyl group, and the like, and thus may be formed by chemically coupling the ferrite substrate 110 with the primer layer 120.

Further, the primer layer 120 according to the exemplary embodiment of the present invention may be made of a functional group, for example, an acryloyl group, which may be chemically coupled with the resin of the photosensitive insulating layer 130, but is not limited thereto.

A formation material of the primer layer may be one or more material selected from the group consisting of 10-methacryloyloxydecyl dihydrogen phosphate (MDP), 2-methacryloyloxyethyl dihydrogen phosphate (MEP), and 3-trimethoxysilylpropyl methacrylate, but is not limited thereto.

Further, the photosensitive insulating layer according to the exemplary embodiment of the present invention may include one or more polymer material selected from the group consisting of hydroxystyrene derivative, naphthoquinonediazide ester, trisphenol, and melamine compound.

As described above, after the ferrite substrate 110 is chemically coupled with the primer layer 120, the photosensitive insulating layer 130 is applied on the primer layer 120 and the primer layer 120 and the photosensitive insulating layer 130 react with each other. In this case, the functional group included in the primer layer 120 reacts with the resin of the photosensitive insulating layer 130 to form the chemical coupling.

As a result, since the primer layer 120 according to the exemplary embodiment of the present invention has a structure in which the lower ferrite substrate 110 and the upper photosensitive insulating layer 130 are chemically coupled with each other, the thin-layer type common mode filter having the structure may greatly improve the interface adhesion between the ferrite substrate 110 and the photosensitive insulating layer 130.

As illustrated in FIG. 3, even when the exemplary embodiment of the present invention is applied to the structure in which the photosensitive insulating layer and the circuit are formed on both surfaces of the ferrite substrate 110, the primer layers 120 and 220 are each applied on both surfaces of the ferrite substrate 110 and the ferrite material of the ferrite substrate 110 reacts with the functional group of the primer layers 120 and 220 to chemically couple them.

Next, the photosensitive insulating layers 120 and 230 are each applied on each of the primer layers 120 and 220 and the ferrite material of the ferrite substrate 110 reacts with the functional group of the primer layers 120 and 220 to chemically couple them.

Next, even in the thin-layer type common mode filter having the structure of FIG. 3, before the primer layers 120 and 220 are formed on both surfaces of the ferrite substrate 110, both surfaces of the ferrite substrate 110 are mechanically treated to have the constant surface roughness 111 and 211 Ra, thereby improving the adhesion between the ferrite substrate 110 and the photosensitive insulating layers 120 and 230.

The detailed material or reaction of the ferrite substrate 110, the primer layers 120 and 220, and the photosensitive insulating layers 130 and 230 which are included in the structure is the same as the case in which the primer layer is formed on one surface of the ferrite substrate as illustrated in FIG. 2, and therefore the detailed description thereof will be omitted.

Hereinafter, a method for preparing a thin-layer type common mode filter according to the exemplary embodiment of the present invention will be described. The method for preparing a thin-layer type common mode filter according to the exemplary embodiment of the present invention may include applying the primer layer on the ferrite substrate, forming the chemical coupling by reacting the ferrite of the ferrite substrate with the primer layer, applying the photosensitive insulating layer on the primer layer, and forming the chemical coupling by reacting the primer layer with the photosensitive insulating layer.

The ferrite substrate uses a ceramic material and the method for preparing a thin-layer type common mode filter may further include forming the roughness on the surface of the substrate by mechanically surface treating the ferrite substrate.

The primer layer is applied on one surface or both surfaces of the ferrite substrate formed with the surface roughness. The surface roughness of the primer layer is smaller than the surface roughness Ra formed on the sintering ferrite substrate, and thus may be formed at a thickness to be able to maintain the interlayer physical adhesion by making the interface between the primer layer and the photosensitive insulating layer uneven and making the roughness maintain larger than 0, The application method of the primer layer is not particularly limited and the generally known application method may be used.

Next, as the forming of the chemical coupling by reacting the ferrite of the ferrite substrate with the primer layer, the primer layer according to the exemplary embodiment of the present invention has the functional group capable of reacting with the ferrite substrate material, such that the primer layer may be chemically coupled with the material of the ferrite substrate.

Therefore, the primer layer according to the exemplary embodiment of the present invention includes a portion which is formed by being chemically coupled with the ferrite within the ferrite substrate by penetrating the primer material included in the primer layer into the ferrite substrate.

The reaction of the primer layer with the material of the ferrite substrate may be performed under the condition of normal temperature of 15 to 25° C.

At the time of forming the chemical coupling of the primer layer with the ferrite substrate, the chemical coupling is formed by applying the photosensitive insulating layer on the primer layer and reacting the photosensitive insulating layer with the primer layer.

The chemical coupling may be formed by the reaction of the photosensitive insulating with the primer layer, the polymer reaction between the functional group included in the primer layer and the polymer resin included in the photosensitive insulating layer, and the like.

The reaction of the photosensitive insulating layer with the primer layer may be performed under the condition before and after (200° C.±10° C.) about a temperature of 200° C.

According to the exemplary embodiment of the present invention, the thin-layer type common mode filter may be prepared by a process of forming a one-layer internal electrode coil by applying the photosensitive insulating layer and then using the semi-additive process (SAP), forming a two-layer internal electrode coil by forming the via electrode for the interlayer connection on the one-layer internal electrode coil by using the photosensitive insulating layer and then again using the SAP, and the like, and applying the photosensitive insulating layer thereon and then forming an external electrode.

According to the exemplary embodiment of the present invention, the primer layer is formed by the chemical coupling between the ferrite substrate and the photosensitive insulating layer while having the physical adhesion by using the ferrite substrate mechanically surface-treated to have the constant surface roughness, thereby improving the chemical adhesion and improving the interlayer adhesion at the interface between the ferrite substrate and the photosensitive insulating layer.

Meanwhile, the primer layer according to the exemplary embodiment of the present invention may be applied to the process of forming the circuit using the alumina wafer.

According to the exemplary embodiments of the present invention, the separate primer layer chemically coupled with the ferrite substrate and the photosensitive insulating layer can be provided to increase the adhesion between the soft magnetic sintering ferrite substrate used to prepare the thin-layer type common mode filter, and the like, and the insulating layer for molding the circuit. Further, the method for controlling the surface roughness on the soft magnetic sintering ferrite wafer substrate using the physical method can be used to increase the physical adhesion.

Therefore, the thin-layer type common mode filter according to the exemplary embodiments of the present invention can simultaneously apply the mechanical surface treatment method and the primer layer chemically coupled with the ferrite substrate and the photosensitive insulating layer to increase the interlayer adhesion, thereby increasing the reliability of the common mode filter.

What is claimed is:

1. A thin-layer type common mode filter, comprising:
a ferrite substrate;
a primer layer formed on the ferrite substrate; and
a photosensitive insulating layer formed on the primer layer,
wherein the primer layer is formed by chemically coupling the ferrite substrate with the photosensitive insulating layer.

2. The thin-layer type common mode filter according to claim 1, wherein the primer layer includes a portion which is formed by being chemically coupled with ferrite within the ferrite substrate by penetrating a primer material included in the primer layer into the ferrite substrate.

3. The thin-layer type common mode filter according to claim 1, wherein the ferrite substrate has a surface roughness of 0.4 to 0.8 μm.

4. The thin-layer type common mode filter according to claim 3, wherein the surface roughness of the ferrite substrate is formed with mechanical surface treatment.

5. The thin-layer type common mode filter according to claim 3, wherein a thickness of the primer layer to the surface roughness of the ferrite substrate is 0.1 to 50%.

6. The thin-layer type common mode filter according to claim 1, wherein the primer layer is made of a material including two or more functional groups which is chemically coupled with the ferrite substrate and the photosensitive insulating layer.

7. The thin-layer type common mode filter according to claim 6, wherein the material including the two or more functional groups includes one or more material selected from the group consisting of 10-methacryloyloxydecyl dihydrogen phosphate (MDP), 2-methacryloyloxyethyl dihydrogen phosphate (MEP), and 3-trimethoxysilylpropyl methacrylate.

8. The thin-layer type common mode filter according to claim 1, wherein the primer layer has a thickness of 1 to 200 nm.

9. The thin-layer type common mode filter according to claim 1, wherein the primer layer is formed on one surface or both surfaces of the ferrite substrate.

10. The thin-layer type common mode filter according to claim 1, wherein the ferrite substrate is made of one or more material selected from the group consisting of spinel ferrite, garnet ferrite, hexagonal ferrite, and a mixed ferrite thereof.

11. The thin-layer type common mode filter according to claim 1, wherein the photosensitive insulating layer is made of one or more material selected from the group consisting of hydroxystyrene derivative, naphthoquinonediazide ester, trisphenol, and melamine compound.

12. A method for preparing a thin-layer type common mode filter, comprising:
applying a primer layer on a ferrite substrate;
forming chemical coupling by reacting ferrite of the ferrite substrate with the primer layer;
applying a photosensitive insulating layer on the primer layer; and
forming the chemical coupling by reacting the primer layer with the photosensitive insulating layer.

13. The method according to claim 12, further comprising:
forming surface roughness of the substrate by mechanically surface-treating the ferrite substrate.

14. The method according to claim 12, wherein the primer layer is formed on one surface or both surfaces of the ferrite substrate.
